(19) United States
(12) Patent Application Publication
(10) Pub. No.: US 2026/0153693 A1
(43) Pub. Date: Jun. 4, 2026

(54) 360-DEGREE ADJUSTABLE, HIGH-PRECISION OPTICAL FIBER CONNECTOR

(71) Applicant: Dongguan Bulls Technology Co., Ltd., Dongguan (CN)

(72) Inventor: Langlang Zhu, Dongguan (CN)

(21) Appl. No.: 19/019,593

(22) Filed: Jan. 14, 2025

(30) Foreign Application Priority Data
Nov. 29, 2024 (CN) 202422949767.0

(51) Int. Cl. G02B 6/38

(52) U.S. Cl. CPC G02B 6/3874

(57) ABSTRACT

A 360-degree adjustable, high-precision optical fiber connector, includes an optical fiber, an outer housing, an adjustable ferrule assembly for the optical fiber to pass therethrough, a motion stopper assembly, and a tail sleeve. The adjustable ferrule assembly includes a frame sleeve, a ferrule, a ferrule tail handle, a spring, and an orientation sleeve. A positioning mechanism is provided between the frame sleeve and the orientation sleeve to limit the relative position of the two. The ferrule structure has two independent components, namely, the orientation sleeve and the ferrule tail handle connected to the ferrule. After the optical fiber is processed, it is rotated and axially aligned under a microscope. The ferrule tail handle is rotatable freely 360 degrees within the orientation sleeve, enabling high-precision axial alignment. The insertion loss is reduced, the interchangeability is improved, and the polarization transmission characteristics is maintained with high-precision.

### CROSS REFERENCE TO RELATED APPLICATIONS

The present application claims the benefit of Chinese Patent Application No. 202422949767.0 filed on Nov. 29, 2024, the contents of which are incorporated herein by reference in their entirety.

### TECHNICAL FIELD

The present application belongs to the field of optical fiber communication technology, and particularly it is a 360-degree adjustable, high-precision optical fiber connector.

### BACKGROUND TECHNOLOGY

With the continuous development of the optical fiber communication industry, the communication speed continues to increase. People have higher and higher requirements for the optical fiber connection technology. Existing connector structures have become increasingly difficult to meet the needs of the industry.

The existing optical fiber connectors mainly include ordinary optical fiber connectors and polarization-maintaining optical fiber connectors, and the problems existing in these connectors are mainly as follows:
1. In order to reduce insertion loss of the ordinary optical fiber connectors, high-precision optical fiber connection usually requires assembly after point adjustment. By adjusting the eccentricity direction of the optical fiber to the direction of the key on the outer housing of the connector, the loss caused by excessive concentricity mismatch due to the optical fibers being offset in different directions when different connectors are interchanged can be minimized. Existing connectors are affected by their structures. The ferrule tail seat can only be rotated in four directions in an open slot, and it can only rotate 90 degrees at a time. This limits the possibility of further improvement of the consistency of the axial alignment accuracy.
2. Polarization-maintaining fiber connectors have more stringent alignment requirements for the key, typically requiring control within a range of +/−3 degrees, with stricter requirements of +/−1 degree. Due to the influence in the existing connector structures, it is usually necessary to rotate the optical fiber before the adhesive in the connector cures, find the appropriate position, and then heat the fiber or cure it with UV adhesive. On the one hand, it is quite difficult to treat the end face of the optical fiber before the adhesive cures. On the other hand, the optical fiber is very small and can easily be damaged and broken during rotation. In addition, some companies produce protrusions on the motion stopper, and realize axial alignment after curing by rotating the motion stopper. However, this method can cause changes in the preload force of the spring inside the connector, leading to instability in quality. Due to the small gap, the motion stopper needs to be rotated and aligned with the groove of the tail handle by feeling in a completely invisible environment, making it very difficult to assemble.

### SUMMARY

In order to overcome the defects in the existing technology, an object of the present application is to provide a 360-degree adjustable, high-precision optical fiber connector.

The present application adopts the following technical scheme: a 360-degree adjustable, high-precision optical fiber connector, including an optical fiber, an outer housing, an adjustable ferrule assembly for the optical fiber to pass therethrough, a motion stopper assembly, and a tail sleeve; the adjustable ferrule assembly including a frame sleeve, a ferrule, a ferrule tail handle, a spring, and an orientation sleeve; wherein one end of the orientation sleeve is disposed in the frame sleeve, a positioning mechanism is provided between the frame sleeve and the orientation sleeve to limit the relative position of the frame sleeve and the orientation sleeve, one end of the ferrule tail handle is mounted at a tail portion of the ferrule, another end extends out from the orientation sleeve, and the ferrule tail handle is rotatable freely 360 degrees in the orientation sleeve.

In a preferred embodiment, the motion stopper assembly includes a motion stopper and a support member, one end of the motion stopper is mounted in a tail end of the frame sleeve and is positioned at a periphery of the orientation sleeve, a spring is sleeved around the orientation sleeve, two ends of the spring are elastically abutted against the orientation sleeve and the motion stopper respectively, and the spring is used for limiting a horizontal position of the orientation sleeve.

In a preferred embodiment, another end of the orientation sleeve extends out from the motion stopper, a tail portion of the orientation sleeve is provided in a circumferential direction with a plurality of holes, after an angle of the ferrule tail handle is adjusted, the orientation sleeve and the ferrule tail handle are fixed together by spot welding or adhesive bonding.

In a preferred embodiment, the positioning mechanism includes a groove and a protrusion that are correspondingly provided in the frame sleeve and an end face of the orientation sleeve respectively, the groove and the protrusion are engaged with each other.

In a preferred embodiment, the ferrule has a light-transmitting hole opened in a horizontal direction for the optical fiber to pass therethrough, one end of the ferrule is provided in the frame sleeve, and another end of the ferrule protrudes from a front end of the frame sleeve.

In a preferred embodiment, one end of the support member is correspondingly mounted in a tail end of the motion stopper, and another end of the support member is connected with the tail sleeve.

In a preferred embodiment, the outer housing is sleeved around the adjustable ferrule assembly, and an outer surface of the outer housing is protruded to form a key corresponding to an off-center direction of the optical fiber.

To sum up, due to the adoption of above-mentioned technical scheme, the beneficial effects of the present application are that:
1. In the present application, the ferrule structure is designed as two independent components, which include an orientation sleeve and a ferrule tail handle connected to the ferrule. During assembly, the optical fiber is inserted and cured in a normal manner. After curing, the end face of the optical fiber is polished. After polishing, the components are rotated and axially aligned under a microscopic equipment. On one hand, the polished end face of the optical fiber is very clear, making it easy to identify and position. On the other hand, the ferrule tail handle can rotate freely 360 degrees within the orientation sleeve, enabling high-precision axial adjustment. As a result, the insertion loss of the product is reduced, the interchangeability is improved, and the polarization transmission characteristics is maintained with high-precision.
2. In the present application, the commonly used motion stopper assembly is divided into two parts, namely, a motion stopper and a support member. After adjusting the orientation of the optical fiber, the motion stopper and the support member are connected together. On one hand, it can realize pre-assembly of the adjustable ferrule assembly and the motion stopper, and improve production efficiency. In addition, the orientation sleeve and the ferrule tail handle are protruding from a tail end of the motion stopper, facilitating operations such as adjustment and adhesive dispensing.
3. In the present application, the optical fiber can be rotated 360 degrees through the ferrule tail handle, enabling high-precision orientation adjustment of the polarization-maintaining optical fiber connectors as well as single-fiber multi-core connectors.

### DESCRIPTION OF THE DRAWINGS

FIG. 1 is a schematic diagram of the plane structure of the entire application with an optical fiber after it is disassembled;

FIG. 2 is a schematic diagram of the exploded three-dimensional structure of an adjustable ferrule assembly and a motion stopper assembly of the application;

FIG. 3 is a schematic diagram of the plane structure of the entire application without an optical fiber;

FIG. 4 is a schematic diagram of the cross-sectional plane structure of the entire application without an optical fiber;

FIG. 5 is a schematic diagram of the three-dimensional structure of a motion stopper mounted in the adjustable ferrule assembly of the application;

FIG. 6 is a schematic diagram of the plane structure of the adjustable ferrule assembly of the application as viewed from the side.

Symbols in the drawings: 1—outer housing, 11—key, 2—adjustable ferrule assembly, 21—frame sleeve, 211—groove, 22—ferrule tail handle, 23—orientation sleeve, 231—protrusion, 232—hole, 24—spring, 25—ferrule, 251—light-transmitting hole, 3—support member, 4—optical fiber, 5—tail sleeve, 6—motion stopper.

### DETAILED EMBODIMENTS

In order to make the purpose, the technical solution and the advantages of the present application more clearly understood, the present application is further described in detail below in conjunction with the accompanying drawings and embodiments. It should be understood that the specific embodiments described herein are used only to explain the present application and are not intended to limit the present application.

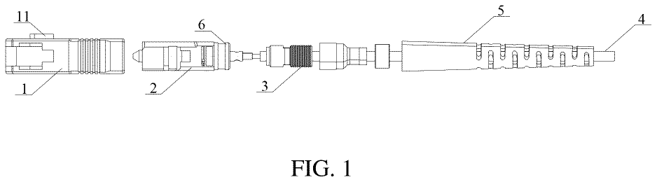

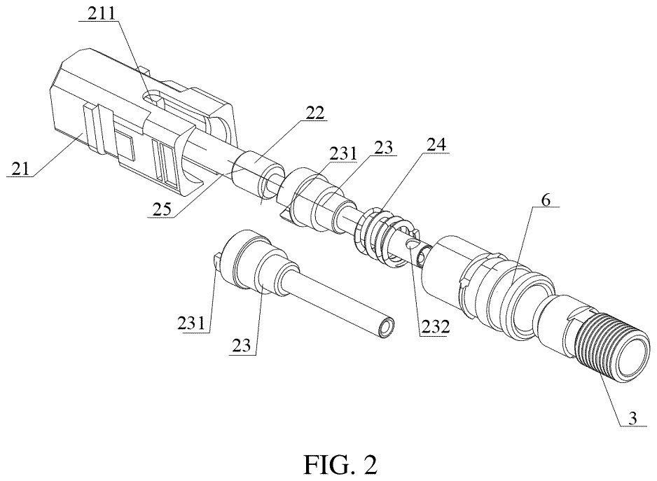

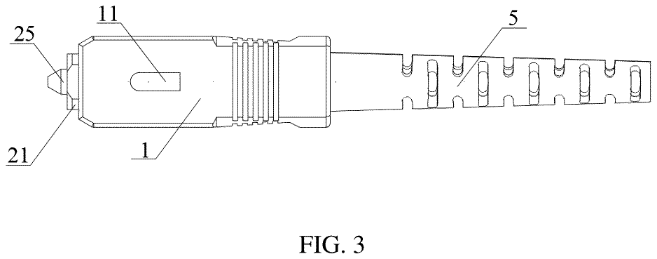

A 360-degree adjustable, high-precision optical fiber connector, referring to FIGS. 1-6, includes an optical fiber 4, an outer housing 1, an adjustable ferrule assembly 2 for the optical fiber 4 to pass therethrough, a motion stopper assembly, and a tail sleeve 5. The adjustable ferrule assembly 2 includes a frame sleeve 21, a ferrule 25, a ferrule tail handle 22, a spring 24, and an orientation sleeve 23. One end of the orientation sleeve 23 is disposed in the frame sleeve 21. A positioning mechanism is provided between the frame sleeve 21 and the orientation sleeve 23 to limit the relative position of the two. One end of the ferrule tail handle 22 is mounted at a tail portion of the ferrule 25, and another end extends out from the orientation sleeve 23. The ferrule tail handle 22 is rotatable freely 360 degrees in the orientation sleeve 23. The ferrule structure is designed as two independent components, which include the orientation sleeve 23 and the ferrule tail handle 22 connected to the ferrule 25. During assembly, the optical fiber 4 is inserted and cured in a normal manner. After curing, the end face of the optical fiber 4 is polished. After polishing, the components are rotated and axially aligned under a microscopic equipment (such as microscope, magnifier, etc.). The polished end face of the optical fiber is very clear, making it easy to identify and position. The can increase the entire axial alignment accuracy. The ferrule tail handle 22 can rotate freely 360 degrees within the orientation sleeve 23, realizing high-precision axial alignment, and thereby reducing the insertion loss of the product and improving its interchangeability. The ferrule tail handle 22 is also used as an axial alignment part. It cannot interfere with the preload force of the spring 24 itself. In this way, it can also ensure the stability of the quality of optical fiber connector, and satisfy the development needs of connector.

It should be mentioned that the above structure can also be applied to FC-type optical fiber connectors, LC-type optical fiber connectors, and there is no limitation here.

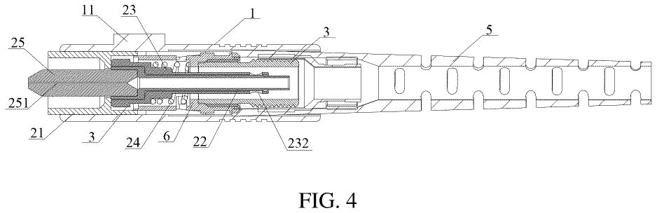

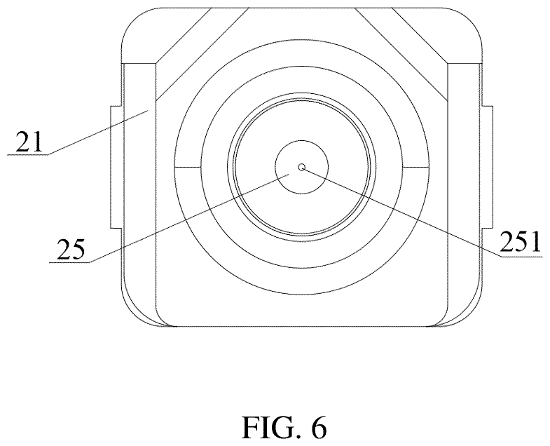

Referring to FIG. 4 and FIG. 6, the ferrule 25 has a light-transmitting hole 251 opened in a horizontal direction for the optical fiber 4 to pass therethrough. One end of the ferrule 25 is disposed in the frame sleeve 21, and the other end of the ferrule 25 protrudes from a front end of the frame sleeve 21. There may be one or more light-transmitting holes 251 that satisfy the positioning operation of single-core optical fibers as well as single-fiber multi-core optical fibers. Before adjusting the angle of the optical fiber 4, adhesive is injected into the hole of the ferrule tail handle 22. The optical fiber 4 is then inserted into the light-transmitting hole 251 of the ferrule 25 along the ferrule tail handle 22. After heating and curing, the combined operation of the optical fiber 4, the ferrule tail handle 22, and the ferrule 25 can be realized.

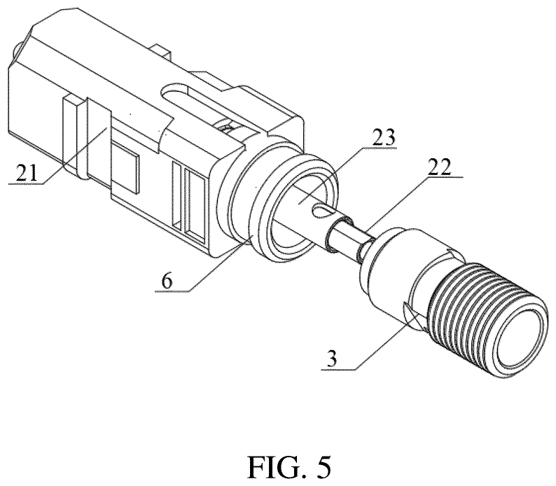

Referring to FIG. 4 and FIG. 5, the motion stopper assembly includes a motion stopper 6 and a support member 3. One end of the motion stopper 6 is mounted in a tail end of the frame sleeve 21 and is positioned at the periphery of the orientation sleeve 23. The spring 24 is sleeved around the orientation sleeve 23, and two ends of the spring are elastically abutted against the orientation sleeve 23 and the motion stopper 6 respectively. The spring is used for limiting the horizontal position of the orientation sleeve 23. The other end of the orientation sleeve 23 extends out from the motion stopper 6. One end of the support member 3 is correspondingly mounted in a tail end of the motion stopper 6, and the other end of the support member 3 is connected with the tail sleeve 5. The commonly used motion stopper assembly is divided into two parts, namely, the motion stopper 6 and the support member 3. After adjusting the orientation of the optical fiber 4, the motion stopper 6 and the support member 3 are connected together. On one hand, this can realize pre-assembly of the adjustable ferrule assembly 2 and the motion stopper 6, and improve the production efficiency. In addition, the orientation sleeve 23 and the ferrule tail handle 22 are protruding from the tail end of the motion stopper 6, facilitating operations such as adjustment and adhesive dispensing.

Among them, the motion stopper 6 preferably adopts a thread connection method for connecting with the frame sleeve 21. The connection method can also be adhesive bonding or welding, and is not limited here.

Furthermore, a tail portion of the orientation sleeve 23 is provided in a circumferential direction with a plurality of holes 232. After the angle of the ferrule tail handle 22 is adjusted, the orientation sleeve 23 and the ferrule tail handle 22 are fixed together by spot welding or adhesive bonding. The reserved holes 232 can be used as adhesive dispensing positions. There are at least two holes 232, but it is not limited here. The angle between the orientation sleeve 23 and the frame sleeve 21 is fixed. Hence, after the orientation sleeve 23 is fixed together with the ferrule tail handle 22, the fixing operation of the relative position of the ferrule tail handle 22 and the ferrule 25 can also be guaranteed.

Furthermore, the positioning mechanism includes a groove 211 and a protrusion 231 that are correspondingly provided in the frame sleeve 21 and an end face of the orientation sleeve 23 respectively. The groove 211 and the protrusion 231 are engaged with each other. The number of the positioning mechanism is at least one, and it can also be multiple. When the groove 211 is located in the frame sleeve 21, the end face of the orientation sleeve 23 is the protrusion 231 that mates with the groove 211. Of course, other positioning mechanisms can also be used to achieve the locking operation. If a polygon groove is provided in the frame sleeve 21, a polygon structure on the end face of the orientation sleeve 23 is designed to mate with the polygon groove. However, it is not limited here.

Furthermore, the outer housing 1 is sleeved around the adjustable ferrule assembly 2. An outer surface of the outer housing 1 is protruded to form a key 11 corresponding to an off-center direction of the optical fiber 4. The key 11 is used herein as an auxiliary positioning point of the mounting angle of the optical fiber 4. It can reduce the loss caused by excessive concentricity mismatch due to the optical fibers being offset in different directions when different connectors are interchanged.

The specific assembly principle of the present application is that: the adjustable ferrule assembly 2 and the motion stopper 6 are pre-assembled. Adhesive is injected into the ferrule tail handle 22. After the optical fiber 4 is inserted, heat is applied and curing can be completed. After curing is completed, the end face of the optical fiber 4 is polished. Then, the end face of the optical fiber 4 is observed under the microscopic equipment. The ferrule tail handle 22 is rotated according to the required position, and the optical fiber 4 is adjusted to a suitable angle. Then, the position of the ferrule tail handle 22 and the orientation sleeve 23 is fixed using adhesive dispensing or welding. In this way, the position of the optical fiber 4 relative to the frame sleeve 21 is fixed. This is equivalent to that the position of the optical fiber 4 relative to the key 11 of the outer housing 1 is also fixed, and then other accessories can be assembled in sequence.

The foregoing is only the preferred embodiments of the present application and is not used to limit the present application. Any modification, equivalent substitution and improvement, etc., made within the spirit and principles of the present application shall be included in the scope of protection of the present application.

What is claimed is:

1. A 360-degree adjustable, high-precision optical fiber connector, characterized in comprising: an optical fiber, an outer housing, an adjustable ferrule assembly for the optical fiber to pass therethrough, a motion stopper assembly, and a tail sleeve; the adjustable ferrule assembly comprising a frame sleeve, a ferrule, a ferrule tail handle, a spring, and an orientation sleeve; wherein one end of the orientation sleeve is disposed in the frame sleeve, a positioning mechanism is provided between the frame sleeve and the orientation sleeve to limit relative position of the frame sleeve and the orientation sleeve, one end of the ferrule tail handle is mounted at a tail portion of the ferrule, another end extends out from the orientation sleeve, and the ferrule tail handle is rotatable freely 360 degrees in the orientation sleeve.

2. The 360-degree adjustable, high-precision optical fiber connector as claimed in claim 1, characterized in that the motion stopper assembly comprises a motion stopper and a support member, one end of the motion stopper is mounted in a tail end of the frame sleeve and is positioned at a periphery of the orientation sleeve, a spring is sleeved around the orientation sleeve, two ends of the spring are elastically abutted against the orientation sleeve and the motion stopper respectively, and the spring is used for limiting a horizontal position of the orientation sleeve.

3. The 360-degree adjustable, high-precision optical fiber connector as claimed in claim 2, characterized in that another end of the orientation sleeve extends out from the motion stopper, a tail portion of the orientation sleeve is provided in a circumferential direction with a plurality of holes, after an angle of the ferrule tail handle is adjusted, the orientation sleeve and the ferrule tail handle are fixed together by spot welding or adhesive bonding.

4. The 360-degree adjustable, high-precision optical fiber connector as claimed in claim 1, characterized in that the positioning mechanism comprises a groove and a protrusion that are correspondingly provided in the frame sleeve and an end face of the orientation sleeve respectively, the groove and the protrusion are engaged with each other.

5. The 360-degree adjustable, high-precision optical fiber connector as claimed in claim 1, characterized in that the ferrule has a light-transmitting hole opened in a horizontal direction for the optical fiber to pass therethrough, one end of the ferrule is disposed in the frame sleeve, and another end of the ferrule protrudes from a front end of the frame sleeve.

6. The 360-degree adjustable, high-precision optical fiber connector as claimed in claim 2, characterized in that one end of the support member is correspondingly mounted in a tail end of the motion stopper, and another end of the support member is connected with the tail sleeve.

7. The 360-degree adjustable, high-precision optical fiber connector as claimed in claim 1, characterized in that the outer housing is sleeved around the adjustable ferrule assembly, and an outer surface of the outer housing is protruded to form a key corresponding to an off-center direction of the optical fiber.
